(19) United States
(12) Patent Application Publication
(10) Pub. No.: US 2011/0203437 A1
(43) Pub. Date: Aug. 25, 2011

(54) Gift wrapping storage dispenser and display

(76) Inventor: Barbara Parravano, Richmond Hill (CA)

(21) Appl. No.: 12/717,182

(22) Filed: Mar. 4, 2010

Related U.S. Application Data
(60) Provisional application No. 61/157,679, filed on Mar. 5, 2009.

(51) Int. Cl. B65D 85/00; B65D 85/67; B65D 85/672; B26D 7/06; B65D 77/00

(52) U.S. Cl. 83/417; 242/588; 206/216

(57) ABSTRACT

There is provided a modular storage and dispensing unit for storing rolls of ribbons and rolls of wrapping paper. The storage dispenser includes a housing having first and second shell portions each having an interior and an opening. The shell portions each have a plurality of mounting elements provided therein. At least one storage container and at least one ribbon roll mount are releasably mountable to the mounting elements. At least one wrapping paper roll mount being releasably mountable to the mounting elements, the wrapping paper roll mount configured to mount the rolls of wrapping paper in the interior along the length of the shell in a parallel arrangement such that all of the wrapping paper rolls are visible through the opening. The storage containers, ribbon roll mounts, and wrapping paper roll mounts all being configured to be mounted in the interior of the shells in a plurality of different positions. The wrapping paper roll mount includes a carousel rotatably mounted within the housing, the carousel configured to mount at least two wrapping paper rolls in an adjacent and parallel arrangement along the length of the shell portion. The wrapping paper roll mount also includes an elongated cutter adjacent the carousel.

### CROSS REFERENCE TO RELATED APPLICATION

This application claims priority from U.S. provisional patent application Ser. No. 61/157,679 filed Mar. 5, 2009, the entirety of which is incorporated herein by reference.

### FIELD OF THE INVENTION

The invention relates generally to storage devices for storing, displaying and dispensing wrapping paper and wrapping accessories.

### BACKGROUND OF THE INVENTION

Gift wrapping is an important part of the retail sector. People purchasing gifts at retail stores often ask that the gifts be wrapped in an attractive fashion. The wrapping of the gift involves first unrolling a length of wrapping paper from a roll of wrapping paper and then cutting it. Since large packages require long sheets of wrapping paper, unrolling the wrapping paper can be a laborious and awkward task. Then the wrapping paper must be cut cleanly perpendicular to its length in order to neatly and efficiently wrap the package. Again, for long lengths of wrapping paper this can be an awkward task requiring more than one person to perform efficiently. Furthermore, additional items are usually required to wrap the package with the wrapping paper, including glue, adhesive tape, scissors, and embellishments such as bows and ribbons. Ribbons, particularly long lengths of ribbon, are similarly awkward to unroll and cut.

To aid people wishing to gift wrap items, various dispensers can be used to hold a roll of wrapping paper as the user unrolls a length of paper from the roll. This makes the task of unrolling the wrapping paper easier; however, it does not address the difficulties associated with cutting the paper to length. Furthermore, the various other accessories required to gift wrap packages must be stored in various packages making it less convenient to find all of the items quickly. Storing all of these items together can be quite awkward, since rolls of wrapping paper come in rolls of various lengths. Furthermore, specialty wrapping paper is often only available as flat sheets, making it difficult to store specialty wrapping paper with long rolls of rolled wrapping paper. Furthermore, the numerous smaller items required for wrapping gifts, such as ribbons, glue, scissors, bows and various other embellishments and tools, are generally smaller than the sheets and rolls of wrapping paper, making it difficult to store all of these items in the same container. An improved wrapping paper dispenser and storage device which neatly stores all of the paper, ribbons and accessories necessary for wrapping gifts in a convenient and easy to carry package would facilitate gift wrapping, both for retailers and for individuals.

### SUMMARY OF THE INVENTION

In accordance with one aspect of the present invention, there is provided a combination storage container and gift wrapping dispenser for storing and dispensing gift wrap and gift wrapping accessories which overcomes the disadvantages of the prior art. The device consists of a modular storage unit having a hinged clam shell housing with two shell portions hinged together and movable between an open and closed position. Each shell portion has a length, a width, a depth, a bottom, opposite first and second ends and opposite first and second sides, the first and second shells housing an interior when the housing is closed up. The shell portions have a plurality of mounting elements provided therein for releasably mounting to one or more storage containers. One or more ribbon roll mounts configured to releasably mount to the mounting elements are also provided, the ribbon roll mounts being configured to mount a plurality of ribbon rolls in a side to side arrangement across the width of the shells. One or more wrapping paper roll mounts configured to be releasably mountable to the mounting elements are also provided, the wrapping paper roll mounts configured to mount the rolls of wrapping paper in a parallel arrangement along the length of the shells. The storage containers, ribbon roll mounts and wrapping paper roll mounts are all dimensioned to fit within the interior to permit the housing to close.

In accordance with another aspect of the invention, there is provided a modular storage and dispensing unit for storing rolls of ribbons and rolls of wrapping paper. The storage dispenser includes a housing having first and second shell portions each having an interior and an opening. The shell portions each have a plurality of mounting elements provided therein. At least one storage container and at least one ribbon roll mount are releasably mountable to the mounting elements. At least one wrapping paper roll mount being releasably mountable to the mounting elements, the wrapping paper roll mount configured to mount the rolls of wrapping paper in the interior along the length of the shell in a parallel arrangement such that all of the wrapping paper rolls are visible through the opening. The storage containers, ribbon roll mounts, and wrapping paper roll mounts all being configured to be mounted in the interior of the shells in a plurality of different positions.

In accordance with another aspect of the present invention, there is provided a dispensing and display unit for rolls of wrapping paper, the dispensing and display unit including a housing having a lid and a shell portion with a width, a length, an interior and an opening. The dispensing and display unit also including a wrapping paper roll mount having a carousel rotatably mounted within the housing, the carousel configured to mount at least two wrapping paper rolls in an adjacent and parallel arrangement along the length of the shell portion. The wrapping paper roll mount also includes an elongated cutter adjacent the carousel.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a perspective view of a modular storage unit made in accordance with the present invention shown it its open position and having a plurality of wrapping paper roll mounts, storage compartments and ribbon roll mounts mounted therein.

FIG. 2 is a perspective view of a modular storage unit made in accordance with the present invention shown in its open position and having a plurality of flat sheet mounts, storage compartments and ribbon roll mounts mounted therein.

FIG. 3 is a perspective view of the shell portion of the storage unit shown in FIG. 1.

FIG. 4 is a front view of the modular storage unit shown in FIG. 2.

FIG. 5 is a perspective view of the modular storage unit shown in figure one angled to show details of the top portion of the storage unit.

FIG. 6 is a back view of the modular storage unit made in accordance with the present invention shown in FIG. 3.

FIG. 7 is a perspective view of the modular storage unit shown in FIG. 1 in its closed position.

FIG. 8 is a perspective view of the modular storage container and the ribbon roll mounts of the present invention.

FIG. 9 is a perspective view of the modular storage unit shown in FIG. 1 showing details of the ribbon roll mount and the wrapping paper roll mount.

FIG. 10 is a perspective view of an alternate embodiment of a modular storage unit made in accordance with the present invention shown it its open position and having a plurality of wrapping paper roll mounts, storage compartments and ribbon roll mounts mounted therein.

FIG. 11 is a perspective view of the wrapping paper roll cartridge assembly portion of the modular storage unit shown in FIG. 10.

FIG. 12 is a perspective view of the wrapping paper roll cartridge assembly shown in FIG. 11 with the lid portion removed.

FIG. 13 is a perspective view of the spindle portion of the wrapping paper roll cartridge assembly shown in FIG. 12.

FIG. 14 is a cross sectional view of the spindle portion shown in FIG. 13.

FIG. 15 is a perspective view of the modular storage unit shown in FIG. 10 with the wrapping paper roll cartridge and bow cartridge removed.

In the drawings like characters of reference indicate corresponding parts in the different figures.

### DETAILED DESCRIPTION OF THE INVENTION

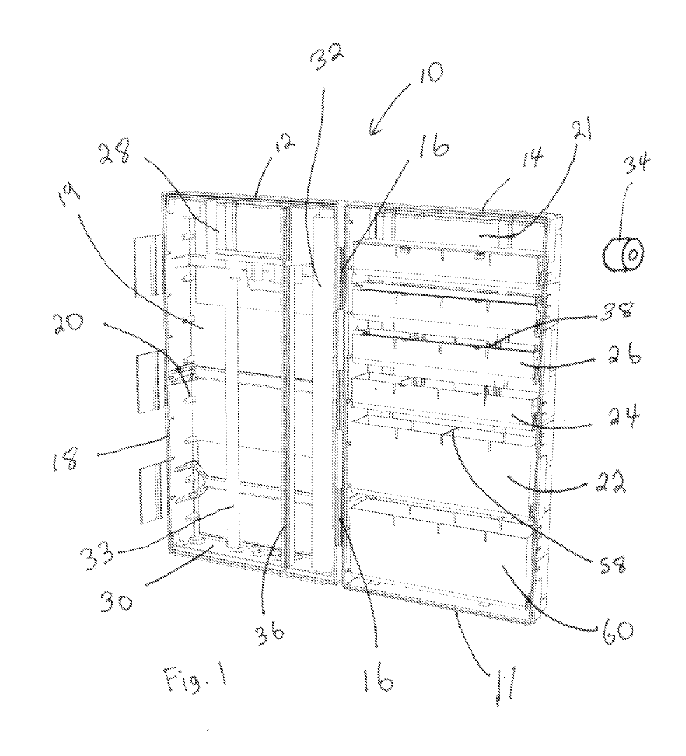

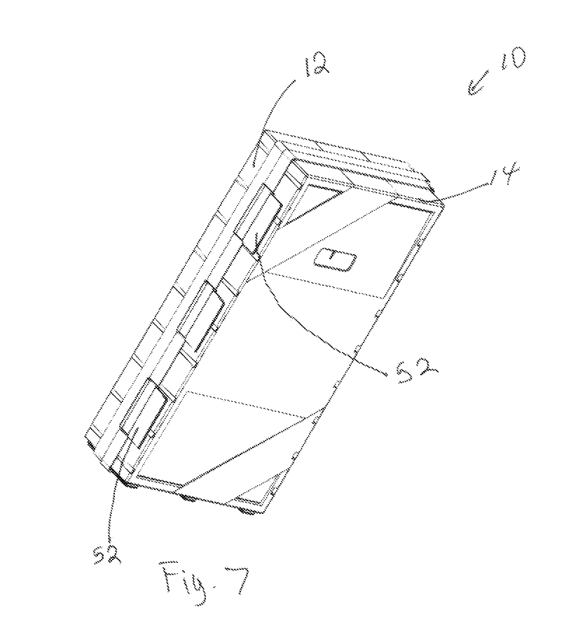

Referring firstly to FIG. 1, the present invention is a modular wrapping paper storage container and dispenser shown generally as item 10. Storage unit 10 consists of a clam shell housing 11 having two shell halves 12 and 14 which are hinged together by hinges 16. Shell halves 12 and 14 have sides 18 which define an interior 19 and 21, respectively. Shell halves 12 and 14 can be pivotally moved between an open position, as shown in FIG. 1, wherein the interiors 19 and 21 can be accessed and a closed position, shown in FIG. 7. As seen in FIG. 1, sides 18 have a plurality of mounting elements 20 formed thereon to permit a plurality of storage containers 22, ribbon roll mounts 26 and wrapping paper roll mounts 28 and 30 to be releasably mounted within shell halves 12 and 14.

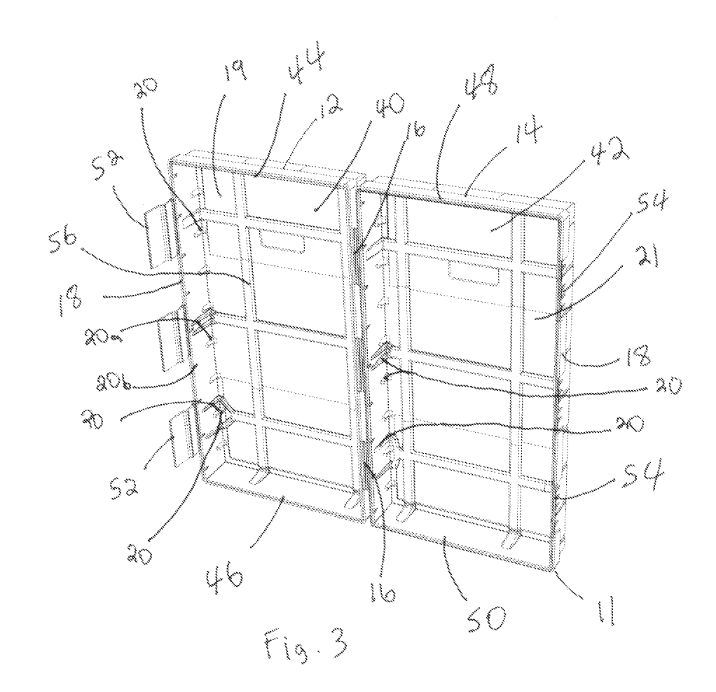

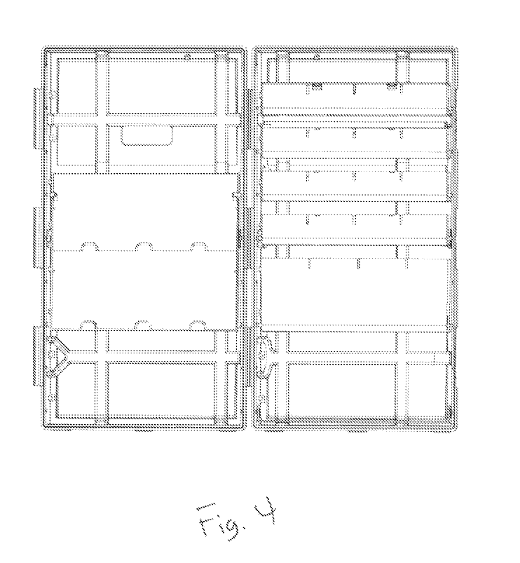

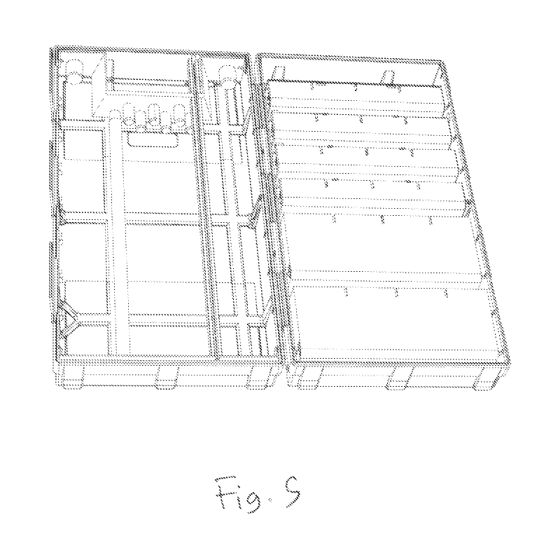

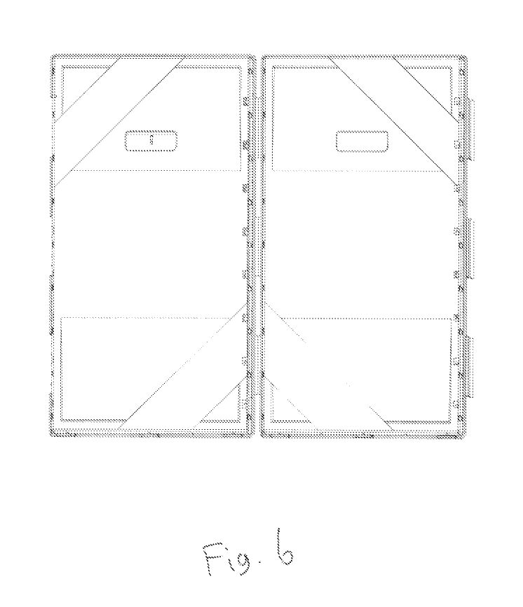

Referring now to FIG. 3, housing 11 is preferably formed of a thermoplastic material, preferably as one molded piece; however, the housing may be made of metal, wood, cardboard or indeed any material. Shell half 12 has sides 18, bottom 40, first end 44, second end 46, and latches 52. Likewise, shell half 14 has sides 18, bottom 42, first end 48, second end 50 and latch catches 54. The two shell portions are joined together by hinges 16. Latches 52, hinges 16 and latch catches 54 are all preferably formed on the shell halves by molding; however, it is possible to form the latches, hinges and latch catches by bonding, riveting or otherwise securing separate parts to the shell halves. Mounting elements 20 are formed within shells 12 and 14, preferably on sides 18; however, the mounting elements may also be formed on bottoms 40 and 42. Mounting elements 20 may comprise hooks, pegs, grooves, tongues or any other connector element which permits easy and quick mounting of a part thereto. It is even possible to use hook and loop fasteners as the mounting elements; however, for ease of construction and to ensure a strong and sturdy connection, mounting elements 20 are preferably formed as integrally molded hooks 20a and grooves 20b on walls 18 of shells 12 and 14. To provide shells 12 and 14 with added structural strength, reinforcing ribs 56 are preferably formed therein as integrally molded structures.

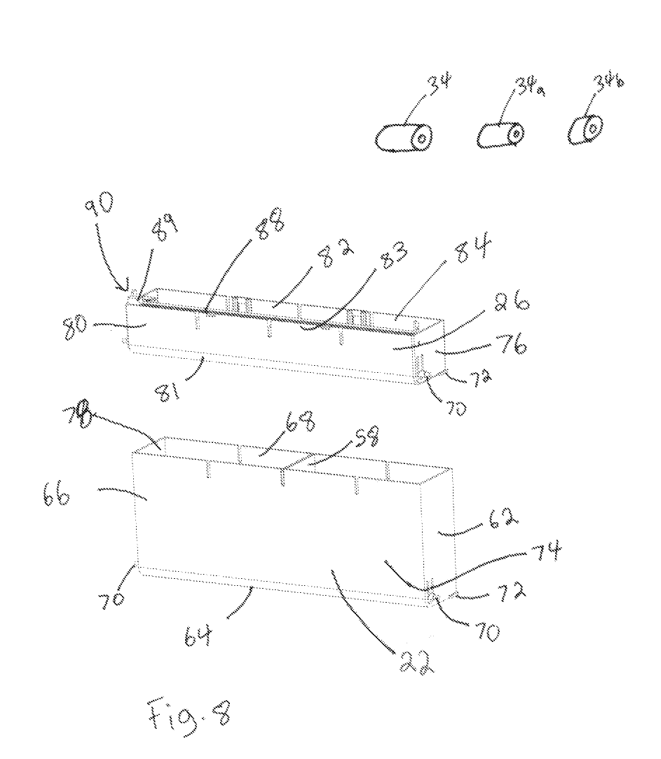

Referring back to FIG. 8, storage containers 22 are essentially rectangular boxes having side walls 62, front wall 66, back wall 68, open top 74, bottom 64 and removable divider 58. Storage container 22 is dimensioned to receive smaller wrapping accessories such as bows, scissors, glue and the like (not shown). The storage container may have an open top 74 or a hinged or removable lid (not shown). Mounting elements 70 and 72 are provided on side walls 62 to permit the storage container to be releasably mounted to walls 18 of shell portions 12 and/or 14 (see FIG. 3). Mounting elements 70 preferably comprise short pegs which are formed on tongue 74 of the side walls of the storage container while mounting elements 72 preferably comprise short tabs. Mounting elements 70 are dimensioned to be snuggly received in mounting elements 20b (see FIG. 3) while mounting elements 72 are dimensioned and configured to hook to mounting elements 20b (see FIG. 3). Preferably, storage container 22 is made of a thermoplastic material, thereby permitting mounting elements 70 to move slightly making it easier to insert the pegs into mounting elements 20b. Storage containers 60 and 24 (see FIG. 1) are substantially identical to storage container 22 differing only in dimensions.

Ribbon roll mounts 26 comprise an elongated housing having side walls 76, front wall 80, back wall 84, bottom 81, interior 82 and an open top 84. Interior 82 is dimensioned to receive ribbon rolls 34, 34a and 34b in a side to side fashion. If the ribbon rolls are of similar diameter, they can be stored in the ribbon roll mount in a substantially coaxially aligned side by side fashion as illustrated. Located on upper lip 83 of front wall 80 is ribbon cutter 90. Ribbon cutter 90 consists of an elongated cutter rail 88 and a sliding cutter 89 which is configured to slide along the cutter rail. Side walls 76 are provided with mounting elements 70 and 72 which are identical to mounting elements 70 and 72 described above.

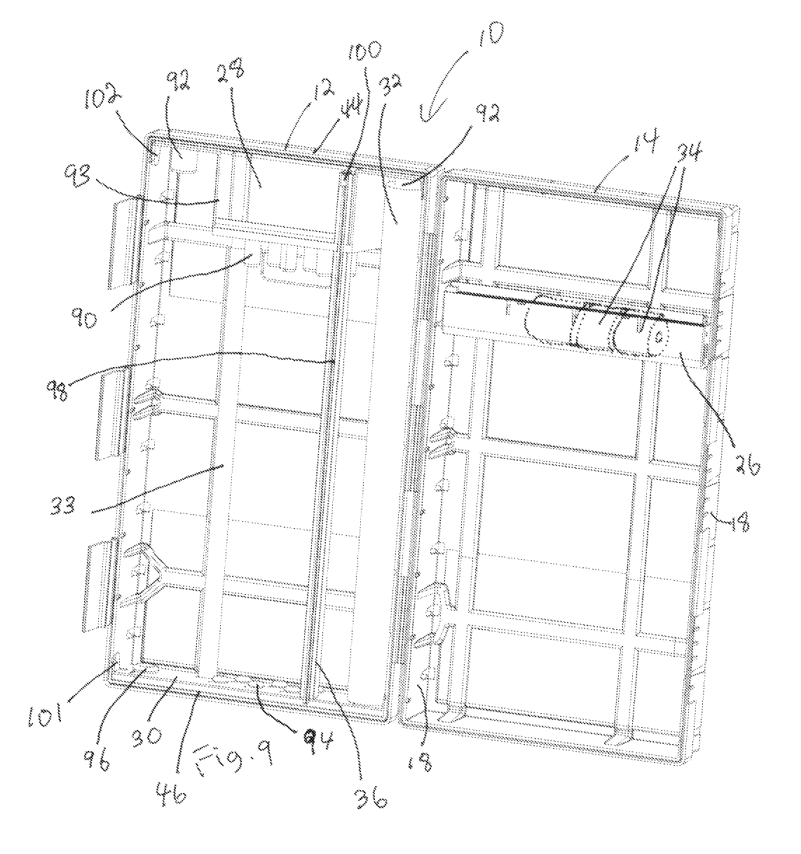

As can be seen in FIG. 9 Ribbon mounts 26 store ribbon rolls 34 across the width of shell portion 14 between side walls 18. Wrapping paper roll mounts 28 and 30 are configured to retain wrapping paper rolls 32 and 33 along the length of shell portion 12 between opposite first and second ends 44 and 46. Wrapping paper roll mount 28 is mounted adjacent end 44 and wrapping paper roll mount 30 is mounted adjacent end 46. Wrapping paper roll mounts 28 have a plurality of nubs 90 and 92 which are coaxially aligned with corresponding nubs 94 and 96, respectively. Nubs 96, 94, 92 and 90 are dimensioned and configured to fit within commercially available roles of wrapping paper such that the rolls or wrapping paper can rotate about their axis to permit wrapping paper to be unrolled off the rolls. Nubs 90 and 92 are longer than nubs 94 and 96 to permit the rolls to be more easily inserted and removed from the unit. Also, since the unit is intended to be stored in an essentially vertical orientation with end 44 pointed upward, the force of gravity will keep wrapping paper rolls 32 and 33 in place. Furthermore, since nubs 90 and 92 are longer than nubs 94 and 96, the wrapping paper roll mounts can be used with wrapping paper rolls of varying lengths since the longer nubs permit some flexibility in the length of rolls which can be mounted. Nubs 90 and 94 are closer together to permit shorter roles of wrapping paper to be mounted, while nubs 92 and 96 are further apart thereby permitting longer rolls of wrapping paper to be mounted. Nubs 90 are positioned closer to nubs 94 by protruding section 93 which is positioned between nubs 92. Wrapping paper roll mounts 28 and 30 have mounting elements 102 and 101, respectively, to permit the roll mounts to be easily and removably mounted within shell half 12.

Elongated cutter 36 is positioned within shell halve 12 and extends along the length of the shell half between ends 44 and 46. Elongated cutter 36 consists of a cutter 100 slidingly retained in a cutting rail 98. Elongated cutter 36 is oriented parallel to nubs 90, 92, 94 and 96 so that when roles 32 and 33 are mounted within the unit, the elongated cutter will be parallel to the roles of wrapping paper, making it easier for the user to cut the paper.

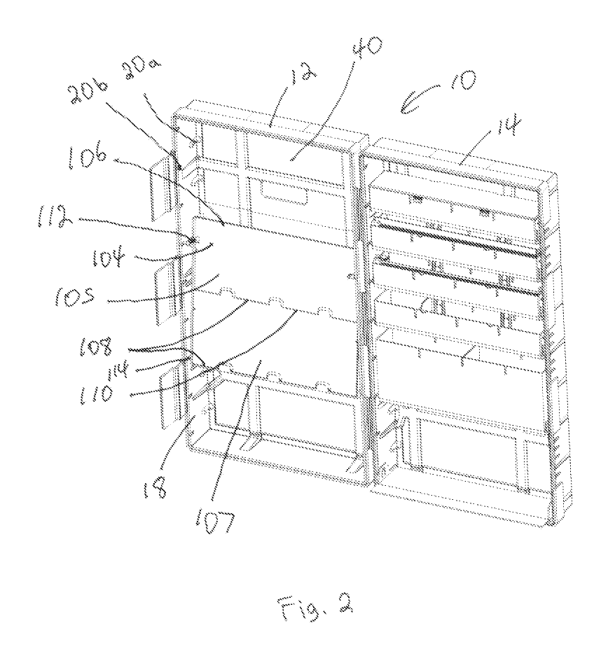

Referring now to FIG. 2, flat sheets of wrapping paper (not shown) may be stored within unit 10 by stacking them on top of flat sheet mounts 104. Flat sheet mounts 104 comprise flat members (or shelves) 105 and 107, each having a lip 110 formed thereon. Flat sheet mounts 104 have mounting elements 112 and 114 for mounting to mounting elements 20a and 20b, respectively, within the shell halves. Flat sheet mounts 104 are configured to hold the flat members at an acute angle to bottom 40 such that end 106 is adjacent bottom 40 and opposite end 108 is contained within the interior of shell half 12. In this way, multiple sheets of flat wrapping paper can be neatly stored on the flat sheet mounts without falling out of the unit.

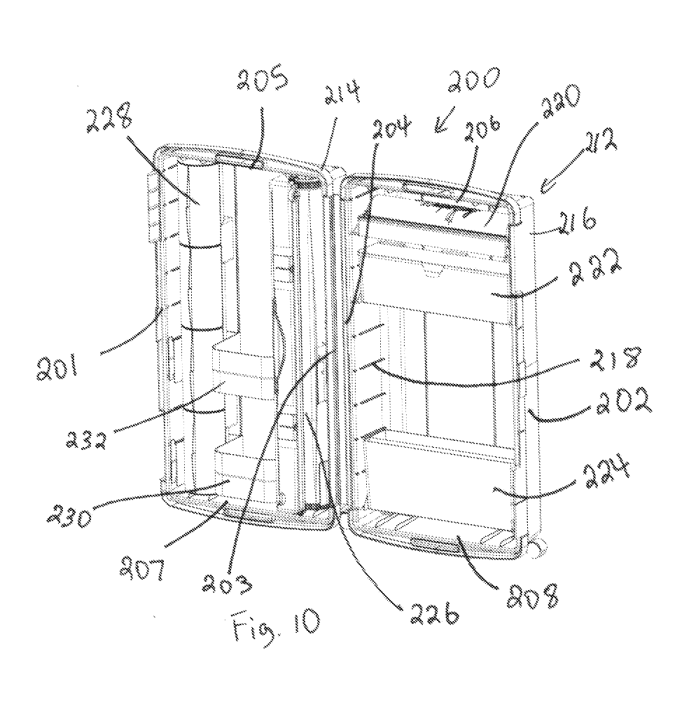

Referring now to FIG. 10, an alternate embodiment of the present invention shown generally as item 200 includes a clam shell housing 212 consisting of two shell halves 214 and 212 as in the previous embodiment. Shell halve 212 has opposite sides 202 and 204 and opposite ends 206 and 208. Shell halve 214 has opposite sides 201 and 203 and opposite ends 205 and 207. The two shell halves are hinged together along sides 203 and 204 as in the previous embodiment. As in the previous embodiment, the shell halves are configured to close together so that the contents of the shell halves are contained within the unit.

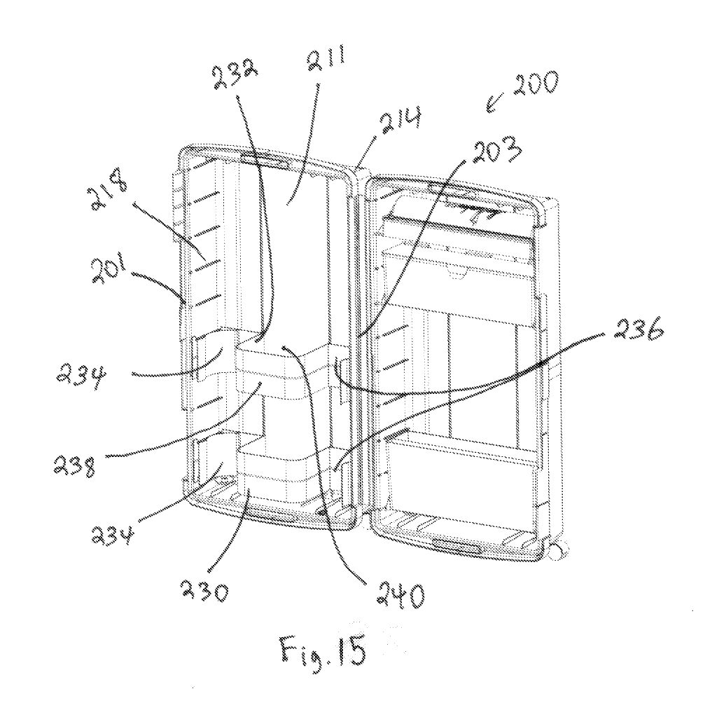

Mounting elements 218 are provided on the inside surface of shell halves 214 and 212 as in the previous embodiment. Ribbon mounts 220 are provided which are releasably mountable within shell halves 212 and 214 as in the previous embodiment. As in the previous embodiment, ribbon mounts 220 are configured to hold a plurality of ribbon rolls (not shown). A plurality of storage compartments 222 and 224 are likewise releasably mountable within the shell halves via mounting elements 218 as in the previous embodiment. The dispensing unit further includes elongated wrapping paper roll dispenser cartridge 226 and elongated bow dispenser cartridge 228. Cartridges 226 and 228 are mounted within shell halve 214 such that the cartridges extend longitudinally between opposite ends 203 and 205 in a parallel fashion. Cartridges 226 and 228 are held in place by cartridge holders 232 and 230. As better seen in FIG. 15, cartridge holders 232 and 230 each have first mounting section 234 which is dimensioned and configured to retain cartridge 228 (FIG. 10) and second mounting section 236 which is dimensioned and configured to retain cartridge 226 (FIG. 10). Cartridge holders 232 and 230 are releasably mountable to the inside surface of the shell halves by means of mounting elements 218. Cartridge holders 232 and 230 have protruding portions 238 between mounting sections 236 and 234. Protruding portions 238 form a space 240 between the cartridge holder and back wall 211 of shell halve 214 to permit addition wrapping paper rolls (not shown) to be contained within the storage unit.

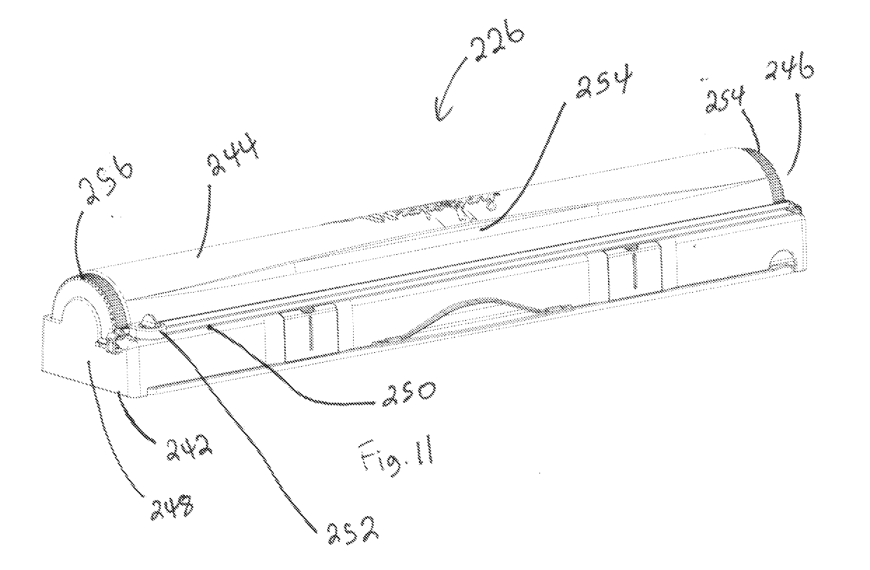

Referring now to FIG. 11, cartridge 226 consists of an elongated housing having back 242, lid 244 and opposite ends 246 and 248. Lip 250 is formed on the housing and carries elongated cutter 252 which extends the length of the cartridge from ends 246 to 248. Gap 254 is provided on lid 244 to permit the user to gain access to the inside of the cartridge without opening lid 244. Cartridge rotators 254 and 256 are provided at ends 246 and 248 of the housing, respectively, and are dimensioned and configured such that a user can easily manipulate them without having to open lid 244.

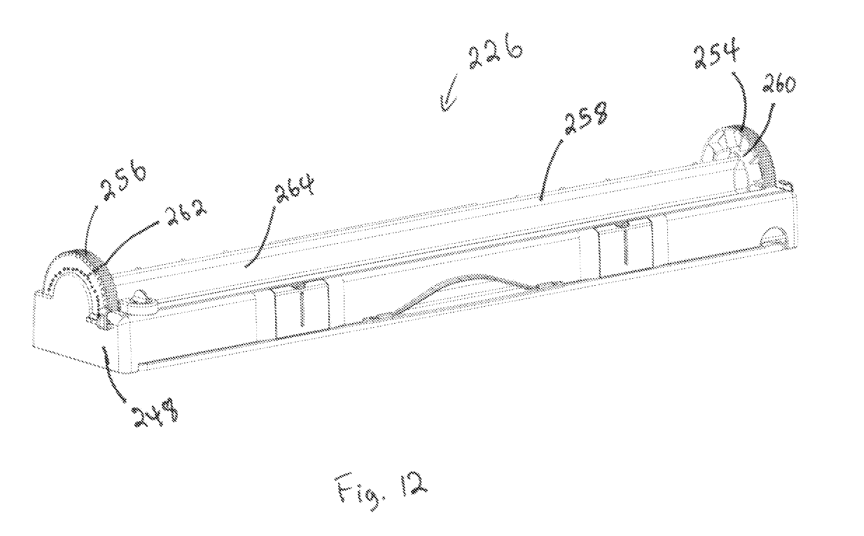

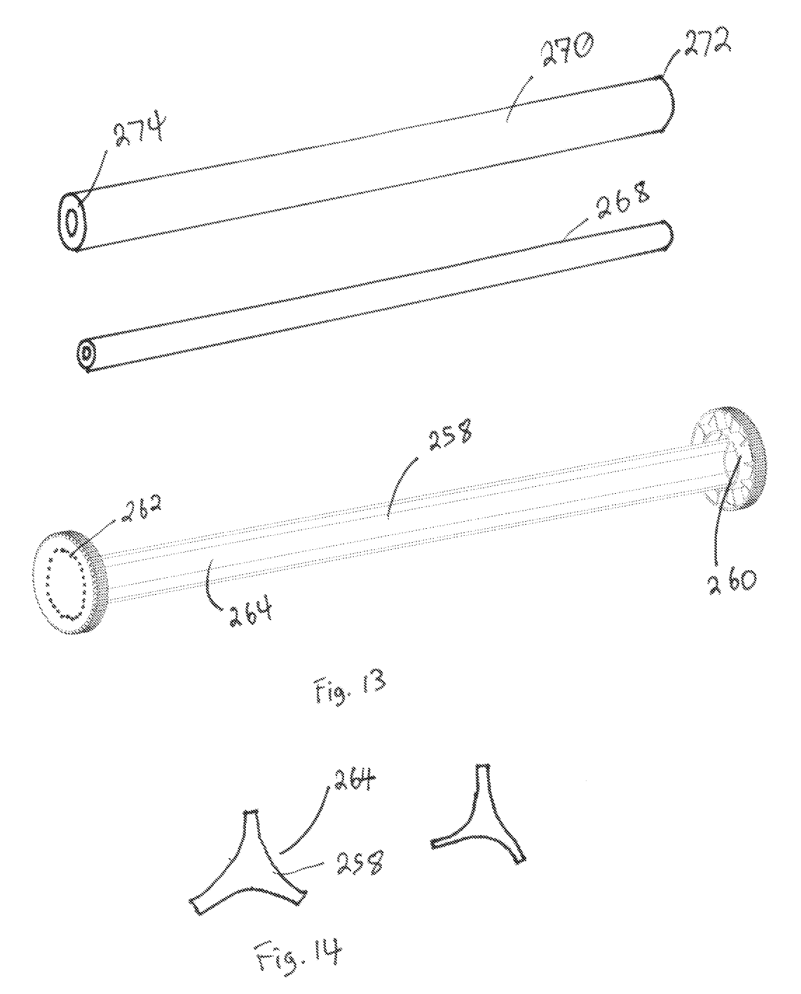

Referring now to FIG. 12, cartridge 226 includes elongated spindle 258 which is coupled to cartridge rotators 254 and 256. Rotators 254 and 256 are circular members which have hub extensions 260 and 262. As better seen in FIGS. 13 and 14, spindle 258 has a three sided cross sectional profile with 3 concave sides 264 which are dimensioned to receive small diameter wrapping paper rolls 268. Hub extensions 260 and 262 and spindle 258 are dimensioned such that large diameter wrapping paper roll 270 can be inserted over spindle 258 with opposite ends 272 and 274 of wrapping paper roll 270 being supported by hub extensions 260 and 262.

Referring back to FIG. 11, cartridge 226 can hold up to 3 small diameter wrapping paper rolls (FIG. 13) or one large diameter wrapping paper roll (FIG. 13). Cartridge 226 is essentially a carrousel which is capable of holding three separate rolls of wrapping paper. Manipulating rotators 254 and 256 permit the user to select the specific wrapping paper roll to be dispensed if multiple rolls are mounted. The user can simply reach in through opening 254 to grasp the wrapping paper and pull out a desired length of paper. The user can then engage cutter 252 to cut the paper to the desired length. As can be seen in FIG. 15, cartridge 226 can be mounted within the storage unit by attachment to attachment members 236. Preferably, attachment members 236 permit cartridge 226 to releasably mount within the housing so that the cartridge can be used outside of the storage unit.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore what is claimed is:

1. A modular storage and dispensing unit for storing gift wrapping accessories, rolls of ribbons and rolls of wrapping paper of different lengths, the unit comprising:
a a hinged clam shell housing having a first and second shell portion hinged together and movable between an open and closed position, each shell portion having a length, a width, a depth, a bottom, opposite first and second ends and opposite first and second sides, the first and second shells housing an interior when the housing is in its closed position;
b the first and second shell portions each having a plurality of mounting elements provided therein;
c a plurality of storage containers releasably mountable to the mounting elements;
d a plurality of ribbon roll mounts releasably mountable to the mounting elements, the ribbon roll mounts configured to mount a plurality of ribbon rolls in a side to side arrangement across the width of the shells;
e a plurality of wrapping paper roll mounts releasably mountable to the mounting elements, the wrapping paper roll mounts configured to mount the rolls of wrapping paper in a parallel arrangement along the length of the shells, and
f the storage containers, ribbon roll mounts and wrapping paper roll mounts all being dimensioned to fit within the interior to permit the housing to close.

2. The modular storage and dispensing unit of claim 1 further comprising a first elongated cutter releasably mountable to the shells and configured to mount across the width of the shell parallel and adjacent to one of the ribbon roll mounts.

3. The modular storage and dispensing unit of claim 1 further comprising a second elongated cutter releasably mountable to the shells and configured to mount along the length of the shell parallel and adjacent to one of the wrapping paper roll mounts.

4. The modular storage and dispensing unit of claim 2 further comprising a second elongated cutter releasably mountable to the shells and configured to mount along the length of the shell parallel and adjacent to one of the wrapping paper roll mounts.

5. The modular storage and dispensing unit of claim 1 wherein the ribbon roll mounts each comprise an elongated bin dimensioned to receive the ribbon rolls in a substantially aligned side to side fashion, the bin extending between the first and second sides of the shell portion.

6. The modular storage and dispenser unit of claim 5 wherein the bin has an open top and further comprising a first elongated cutter mounted across the width of the shell parallel to the elongated bin and adjacent to the open top.

7. The modular storage and dispenser unit of claim 1 wherein the wrapping paper roll mount comprises a first and second end mount dimensioned and configured to releasably mount to the first and second ends of the shell, respectively, the first and second end mounts each having a plurality of nubs, the nubs being dimensioned and configured to hold a roll of wrapping paper.

8. The modular storage dispenser unit of claim 1 wherein the wrapping paper roll mount comprises a first and second end mount dimensioned and configured to releasably mount to the first and second ends of the shell, respectively, the first and second end mounts each having first and second nubs, the first and second end mounts being configured such that the first and second nubs of the first end mount are coaxially aligned with the first and second nubs of the second end mount, respectively, the nubs being dimensioned and configured to hold a roll of wrapping paper between coaxially aligned nubs, the end mounts being configured such that the first nubs hold rolls of wrapping paper of a different length than the second nubs.

9. The modular storage dispenser as defined in claim 1 for use in storing and dispensing a plurality of flat sheets of paper, the unit further comprising at least one flat sheet mount releasably mountable to the mounting elements, the flat sheet mount configured to retain the flat sheets of paper in a stack.

10. The modular storage dispenser of claim 9 wherein the flat sheet mount comprises a flat ledge member having a lip, the lip configured to retain the flat sheets in the stack.

11. The modular storage dispenser of claim 10 wherein the flat ledge member has a length defined by opposite first and second ends, the lip being formed on the first end of the flat ledge and wherein the flat ledge is configured to be mounted to the mounting elements such that the second end of the flat ledge member adjacent the bottom of the shell portion, the ledge member being further configured such that the ledge is held at an acute angle relative to the shell, the acute angle being selected such that the ledge fits completely within the depth of the shell portion within which the ledge is mounted.

12. A modular storage and dispensing unit for storing rolls of ribbons and rolls of wrapping paper comprising:
a a housing having first and second shell portions each having an interior and an opening;
b the shell portions each having a plurality of mounting elements provided therein;
c at least one storage container releasably mountable to the mounting elements;
d at least one ribbon roll mount releasably mountable to the mounting elements;
e at least one wrapping paper roll mount releasably mountable to the mounting elements, the wrapping paper roll mount configured to mount the rolls of wrapping paper in the interior along the length of the shell in a parallel arrangement such that all of the wrapping paper rolls are visible through the opening, and
f wherein the storage containers, ribbon roll mounts, and wrapping paper roll mounts are all configured to be mounted in the interior of the shells in a plurality of different positions.

13. A dispensing and display unit for rolls of wrapping paper, the dispensing and display unit comprising:
a a housing having a lid and a shell portion with a width, a length, an interior and an opening;
b a wrapping paper roll mount having a carousel rotatably mounted within the housing, the carousel configured to mount at least two wrapping paper rolls in an adjacent and parallel arrangement along the length of the shell portion;
c the wrapping paper roll mount having an elongated cutter adjacent the carousel.

14. The dispensing unit of claim 13 further comprising at least one ribbon roll mount mountable within the interior of the shell for storing ribbon rolls in coaxial alignment across the width of the shell.

15. The dispensing unit of claim 14 further comprising at least one storage container mountable within the interior of the shell and wherein the ribbon roll mounts, wrapping paper roll mount and storage containers are configured to be mounted in the interior in a plurality of different positions.

16. The dispensing unit of claim 15 wherein the lid forms a second shell portion having a width, a length, an interior and an opening, both of said shell portions being dimensioned and configured such that the ribbon roll mounts, wrapping paper roll mount and storage containers are all contained within the shells when the shells are closed together.

17. The dispensing unit of claim 16 further comprising a flat sheet mount mountable within the interior of the shells configured to store flat sheets of paper in a, the flat sheet mount comprising a flat ledge mounted at an angle within the shell such that the ledge fits completely within the shell portion within which the ledge is mounted.

18. The modular storage and dispensing unit of claim 13 wherein the carousel is further configured to mount both large diameter wrapping paper rolls and smaller diameter wrapping paper rolls, the carousel comprising an elongated spindle having opposite first and second ends and at least two sides, each side of the spindle configured to receive one of the smaller diameter wrapping paper rolls, the carousel having a first and second hub extension positioned adjacent the first and second ends of the spindle, respectively, the spindle and the first and second hubs being dimensioned to receive one of the larger diameter wrapping paper rolls.

19. The modular storage and dispensing unit of claim 18 wherein the spindle has a three sided profile, each side being concave and wherein the spindle is mounted between first and second circular members, the hub extensions being formed on the circular members adjacent the spindle.

20. The dispensing unit of claim 18 wherein the shell portions are hinged together and wherein the wrapping paper roll mount, ribbon roll mount, storage container and flat sheet mount are all configured to be releasably mountable with the shells in different positions.
